(19) United States
(12) Patent Application Publication
(10) Pub. No.: US 2018/0218303 A1
(43) Pub. Date: Aug. 2, 2018

(54) SYSTEMS AND METHODS FOR ANALYZING WEATHER EVENT IMPACTS ON SCHEDULE ACTIVITIES

(71) Applicant: Weather Build, Inc., Cambridge, MA (US)

(72) Inventors: Peter COLE, Carrabassett Valley, ME (US); Jeffrey COLE, Carrabassett Valley, ME (US); Adam OMANSKY, Boston, MA (US)

(21) Appl. No.: 15/886,193

(22) Filed: Feb. 1, 2018

Related U.S. Application Data
(60) Provisional application No. 62/453,066, filed on Feb. 1, 2017.

(51) Int. Cl. G06Q 10/06; G06K 9/62; G06F 15/18; G06F 17/27

(52) U.S. Cl. CPC G06Q 10/06312; G06K 9/6269; G01W 1/10; G06F 17/2715; G06F 15/18

(57) ABSTRACT

The present disclosure relates to systems and methods for forecasting weather events, and in particular, for forecasting weather-related impacts on schedules for construction projects and capital programs, or any type of project, program and/or operation where weather can influence its outcome. The disclosed systems/methods can include parsing and processing received project activity data to instantiate an activity model for each schedule activity. A machine-trained classifier can be used to predict, for each respective activity model, types of weather events that are expected to impact each schedule activity. Weather forecast data can also be parsed and/or processed to classify forecasted weather events according to multiple pre-defined types of weather events. A report can be generated specifying which schedule activities are expected to be impacted by forecasted weather events.

### RELATED APPLICATIONS

This application claims priority to U.S. Provisional Application No. 62/453,066 titled “SYSTEMS AND METHODS FOR ANALYZING WEATHER EVENT IMPACTS ON SCHEDULE ACTIVITIES” filed on Feb. 1, 2017, the entire contents of which are incorporated herein by reference.

### TECHNICAL FIELD

The present disclosure relates to systems and methods for forecasting weather events, and in particular, for forecasting weather-related impacts on schedules for construction projects and capital programs, or any type of project, program and/or operation where weather can influence its outcome.

### BACKGROUND

The construction industry, as well as many other projects and/or activities, rely on schedules of activities to ensure projects/activities are completed on-time, that resources such as materials, personnel and equipment are shipped to the right place at the right time, and that activities are completed in the proper sequence. Missing milestones in these schedules of activities can cause delays and increase costs.

### SUMMARY OF THE INVENTION

These and other capabilities of the disclosed subject matter will be more fully understood after a review of the following figures, detailed description, and claims. It is to be understood that the phraseology and terminology employed herein are for the purpose of description and should not be regarded as limiting.

According to one aspect, the present disclosure is directed at a method for determining probable impacts of forecasted weather events on schedule activities, the method comprising: receiving, at one or more processors, project activity data; parsing the received project activity data using the one or more processors to determine one or more schedule activities; instantiating, at the one or more processors, an activity model for each of the determined one or more schedule activities, wherein each activity model comprises one or more extracted activity attributes that are determined based on the received project activity data; determining at the one or more processors, for each respective activity model of at least some of the instantiated activity models, one or more types of weather events that may impact the schedule activity corresponding to the respective activity model based on at least one of the extracted attributes for the respective activity model; receiving, at the one or more processors, weather forecast data; parsing the received weather forecast data using the one or more processors to determine one or more forecasted weather events, wherein each forecasted weather event comprises a predefined weather event data structure that defines a weather event type of a plurality of predefined weather event types; processing each activity model to determine which, if any, activity models correspond to a schedule activity that may be impacted by a forecasted weather event; and generating, using the one or more processors, a report specifying which of the one or more schedule activities may be impacted by any of the one or more forecasted weather events.

In some embodiments, the project activity data can be formatted according to a file format.

In some embodiments, the project activity data can be received via a database-to-database connection and can be formatted according to a database format.

In some embodiments, the weather forecast data can comprise text alerts issued by at least one weather forecast authority, wherein the text alerts have not been automatically generated by a computer but have been at least partially drafted by a human operator.

In some embodiments, the weather forecast data can comprise time-series weather forecast data received from at least one of a weather forecast authority and a weather sensor.

In some embodiments, the one or more types of weather events that may impact the schedule activity corresponding to the respective activity model can be determined using a multi-label classifier that has been trained according to a machine learning algorithm.

In some embodiments, the multi-label classifier can be a support vector machine (SVM) classifier that defines a decision hyperplane that differentiates between sets of weather event types that may impact a particular schedule activity and sets of weather event types that are not expected to impact the particular schedule activity.

In some embodiments, the parsing of the received weather forecast data to determine one or more forecasted weather events is accomplished using a weather event classifier that has been trained according to a machine learning algorithm.

In some embodiments, the received project activity data can be associated with a construction project, wherein each schedule activity can be a construction-related activity.

In some embodiments, the generated report can be delivered via at least one of an email, a text message, a laptop or desktop push notification system, a mobile push notification system, an audible notification system, a visual notification system, and a watch push notification system.

According to another aspect, the present disclosure is directed at a system for determining probable impacts of forecasted weather events on schedule activities, the system comprising: one or more communications interfaces configured to receive project activity data and weather forecast data; and one or more processors configured to: parse the received project activity data to determine one or more schedule activities, instantiate an activity model for each of the determined one or more schedule activities, wherein each activity model comprises one or more extracted activity attributes that are determined based on the received project activity data, determine, for each respective activity model of at least some of the instantiated activity models, one or more types of weather events that may impact the schedule activity corresponding to the respective activity model based on at least one of the extracted attributes for the respective activity model, parse the weather forecast data to determine one or more forecasted weather events, wherein each forecasted weather event comprises a predefined weather event data structure that defines a weather event type of a plurality of predefined weather event types, process each activity model to determine which, if any, activity models correspond to a schedule activity that may be impacted by a forecasted weather event, and generate a report specifying which of the one or more schedule activities may be impacted by any of the one or more forecasted weather events.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 illustrates the high-level architecture of the meteorological event and schedule activity impact system.

FIG. 2 illustrates the high-level architecture of the model-view-controller pattern server system.

FIG. 3 illustrates the interaction of specific server controllers and models to manage application data and logic.

FIG. 4 illustrates the system and methods for uploading schedule activities and classifying impacting meteorological event types.

FIG. 5 illustrates a ProjectReport Controller 301 process for classifying meteorological events from a forecast and determining impacted schedule activities.

FIG. 6 illustrates an ImpactedActivity Controller (305) logic for matching schedule activity impacting event types and meteorological events to determine schedule activity impacts.

FIG. 7 illustrates the system and methods for creating and persisting a classifier for meteorological events classification from severe weather alert text.

FIG. 8 illustrates the system and methods for creating and persisting a classifier for meteorological events classification from time series weather forecasts.

FIG. 9 illustrates the system and methods for creating and persisting a classifier for project activity impacting event types from project activity attributes.

FIG. 10 illustrates an exemplary set of training data for an activities classifier.

FIG. 11 illustrates an exemplary set of training data for a severe weather alert meteorological event classifier.

### DETAILED DESCRIPTION

Weather can be a major reason for missed milestones in the construction industry and built environment, and many other market sectors. Weather events (such as snow, rain, high wind, and/or excessively low or high temperatures) can causes schedule delays, decreases labor and equipment productivity, jeopardizes material performance, leads to insurance claims and litigation, and endangers health, safety and the environment.

The currently disclosed meteorological event and schedule activity impact system reads client project schedules and automatically determines weather-event types, such as rain, wind, and lightning, that may impact each schedule activity, such as pouring concrete, welding support beams, and lifting I-beams with crane, using a schedule activities classifier. For example, the schedule activities classifier reads the schedule activity “pouring concrete” and automatically determines that pouring concrete may be impacted by rain, snow, sleet, hail, and frost weather event types. Likewise, the schedule activities classifier reads the schedule activity “lifting I-beams with crane” and automatically determines that this crane-based schedule activity may be impacted by wind, wind gusts, and lightning weather event types. Such schedule activities can encompass all types of planned construction and/or maintenance-related tasks, whether in the context of a construction project that is planned weeks, months, or even years in advance, scheduled maintenance, inspection, or repair, or reactive maintenance or repair jobs in response to unforeseen equipment or structural damage, and which may have been scheduled mere hours in advance.

The meteorological event and schedule activity impact system can then ingest hyper-local weather forecasts and severe weather alert text and automatically determine component weather events, such as rain, snow, wind, and lightning, and their duration from the weather forecast or severe weather alert text using a weather forecast classifier and severe weather alert classifier.

The system can then match the schedule activity impacting event types from the activities classifier with the weather events produced from the weather forecast classifier and severe weather alert classifier to determine potential weather-related impacts to scheduled activities. This determination of potentially impacted schedule activities provides a decision support solution that empowers contractors, owners and other project, program and/or operation stakeholders to improve situational awareness and make better informed decisions about weather events, schedule impacts, and probable outcomes.

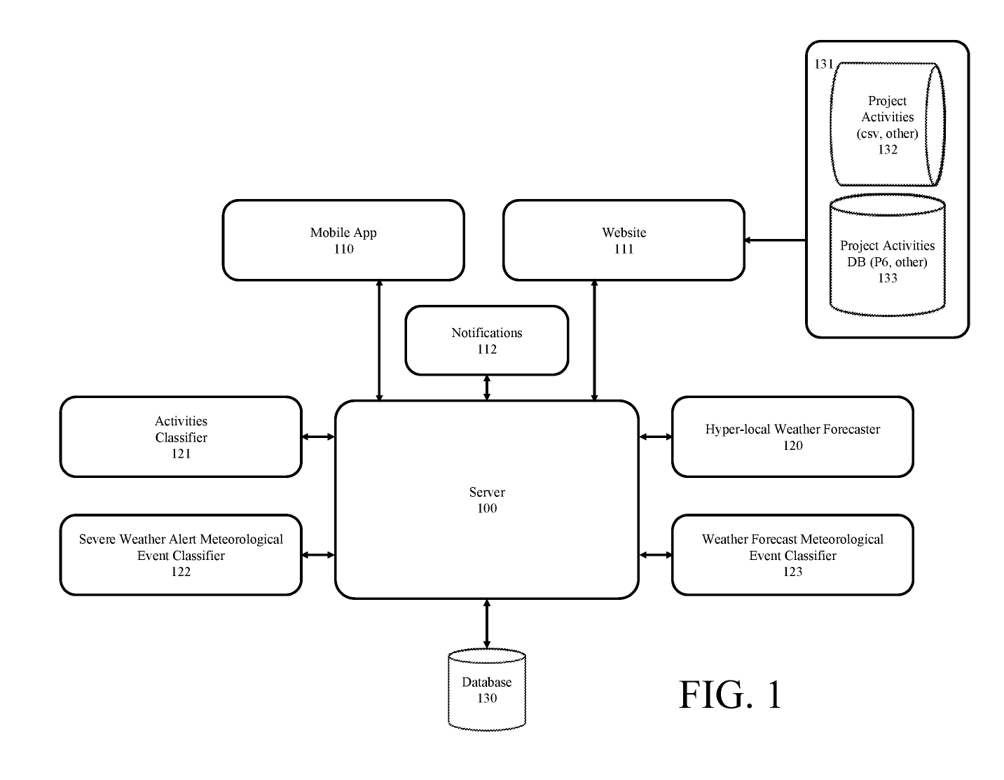

FIG. 1 illustrates the high-level architecture of the meteorological event and schedule activity impact system. The system includes Server 100; client-facing Mobile App 110, Website 111 and Notifications 112; Hyper-Local Weather Forecaster 120, Schedule Activities Classifier 121, Severe Weather Alert Meteorological Event Classifier 122 and Weather Forecast Meteorological Event Classifier 123; Database 130, and Client Input Data 131, which may comprise file-based schedule activities 132 and/or database schedule activities 133.

Server 100 comprises one or more servers that provide data and computation functionality services to programs, models, and devices via a request-response methodology. Server 100 may comprise memory storing computer executable programs, which are executed by one or more processors to implement the functionality described herein. Server 100 may also comprise communications interfaces with external components, including some of the components described below.

Mobile App 110 may be a client facing mobile software application configured to communicate with server 100. Mobile App 110 may be installed on mobile devices, such as smartphones or tablets.

Website 111 may be a client facing commercial website published on a web server and available publicly on the internet. Website 111 may be configured to communicate with and/or be hosted by server 100.

Notifications 112 comprises hardware (e.g., servers, workstations, or processing devices) and/or software that provides real time client facing notification services via email, text message, automated voice message, laptop/desktop push notification systems, mobile push notification systems, mobile application or “app” notification systems, and/or watch push notification systems, which can include alerts, badge application icons, banners, sounds/tones (e.g., a siren sound alerting system from a mobile device), visual notifications (e.g., strobe light alerting system from a mobile device) and/or vibration patterns. Notifications 112 may be configured to communicate with and/or be integrated or hosted by server 100.

Hyper-local Weather Forecaster 120 can be a source of forecast data that provides current, hourly, and/or daily weather forecasts. These weather forecasts may contain information regarding air quality index, apparent temperature, apparent temperature maximum, apparent temperature maximum time, apparent temperature minimum, apparent temperature minimum time, cloud cover, dew point, humidity, lightning, nearest storm bearing, nearest storm distance, ozone, precipitation accumulation, precipitation intensity, precipitation intensity maximum, precipitation intensity maximum time, precipitation probability, precipitation type, pressure, temperature maximum, temperature maximum time, temperature minimum, temperature minimum time, UV index, valid time, visibility, weather summary, wind bearing, wind gust, wind speed, and/or icon description for a certain position. Hyper-local Weather Forecaster 120 may be provided by a local or government weather forecast service. In some embodiments, Hyper-Local Weather Forecaster 120 may also comprise one or more weather sensors configured to measure the aforementioned weather information. Such a weather sensor may be owned or operated by an entity other than a local or government weather forecast service.

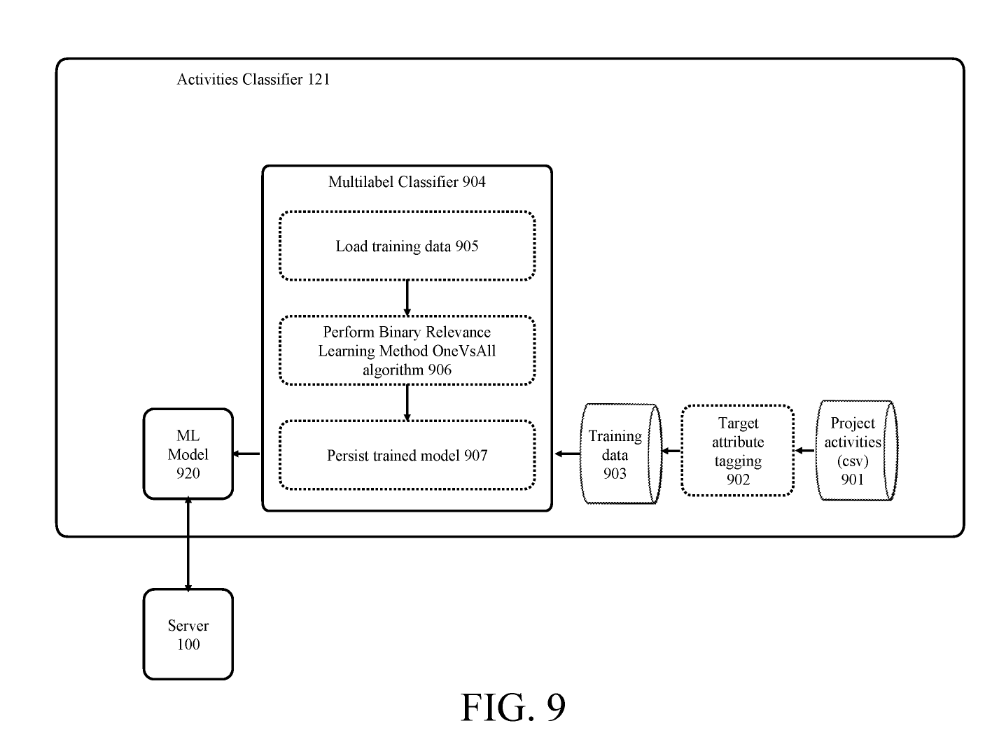

Activities Classifier 121 contains the training, learning, and persisted computer model from supervised machine learning that performs multi-label classification of client project schedule activities. Activities Classifier 121 parses data received from a client to separate out individual activities, and predicts, for each activity, the set of weather event types that may impact that activity. This feature is described in more detail below in connection with FIG. 9.

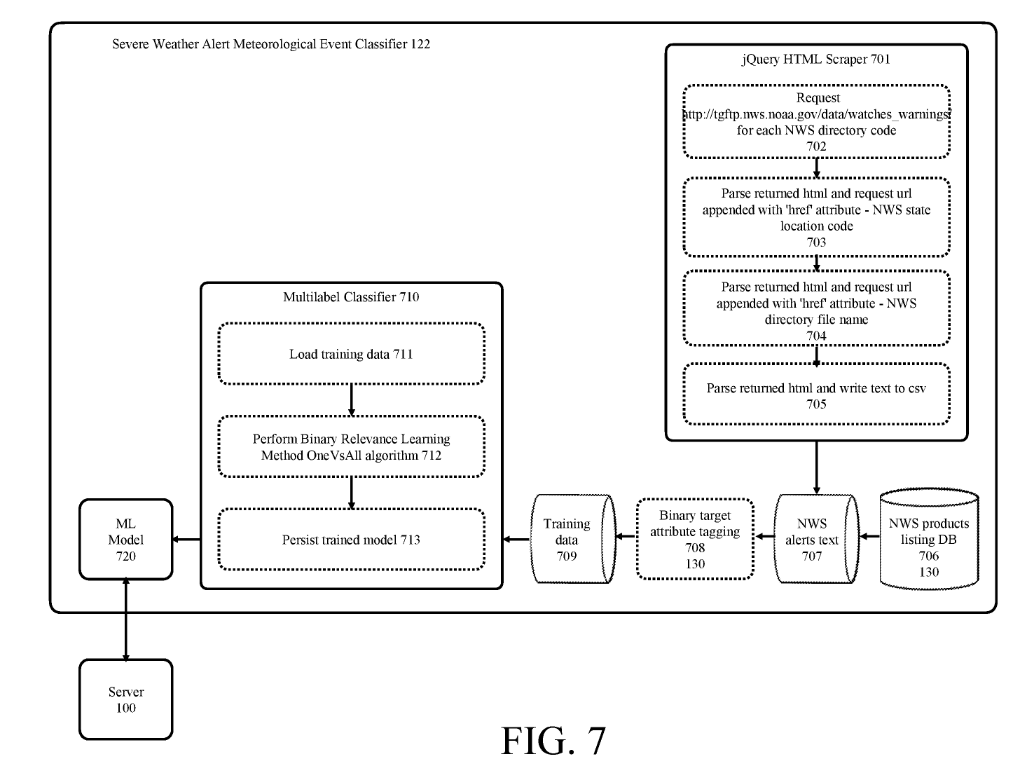

Severe Weather Alert Meteorological Event Classifier 122 contains the training, learning, and persisted computer model from supervised machine learning that performs multi-label classification of weather events from severe weather text alerts, such as National Weather Service (NWS) text alerts. In some embodiments, such text alerts may have been written at least in part by meteorologists and issued by weather forecast authorities or sources, such as the National Weather Service (NWS) or the UK Met Office Severe Weather Warning system. Such text alerts may not have been completely automatically generated by a computer, but may have been at least partially drafted by a human operator. As such, these text alerts may not adhere to a formal taxonomy or code structure, but may describe predicted weather events in prose similar to that used in regular spoken or written communications between humans. The Severe Weather Alert Meteorological Event Classifier 122 processes such text alerts to derive a set of weather event types that are predicted to occur based on the severe weather text alerts, wherein the derived set of weather event types are described according to a formal taxonomy or code structure. This feature is described in more detail below in connection with FIG. 7.

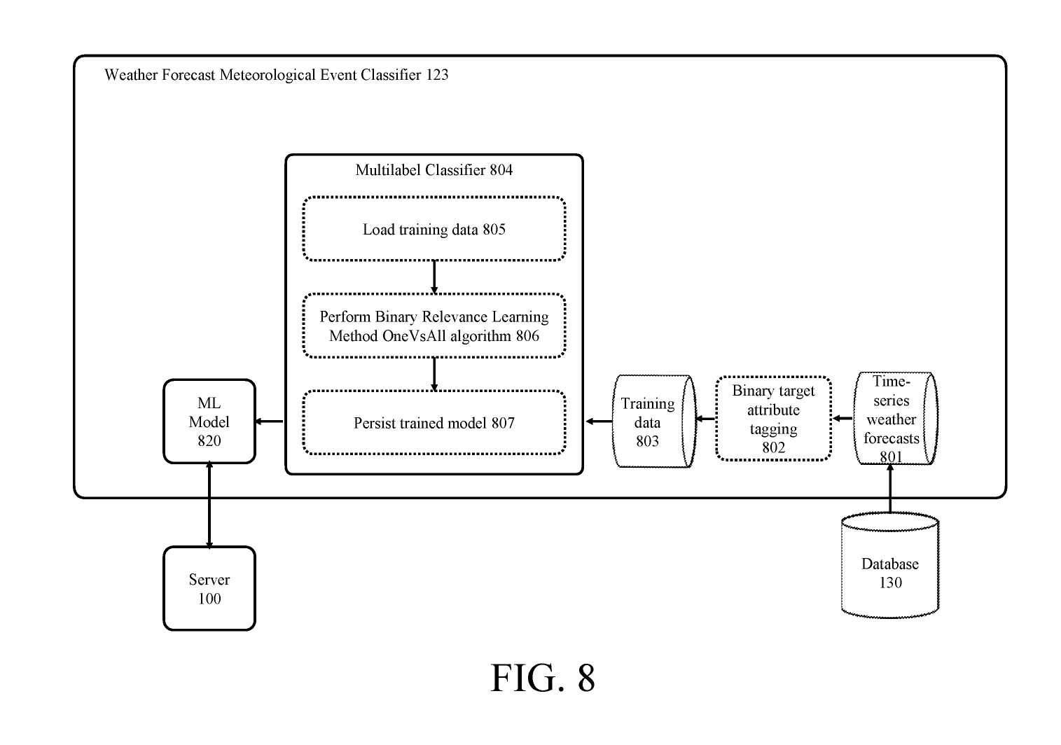

Weather Forecast Meteorological Event Classifier 123 contains the training, learning, and persisted computer model from supervised machine learning that performs multi-label classification of time-series weather data. Such time-series weather data may have been automatically generated by one or more computers, and may have been issued by weather forecast authorities or sources. This feature is described in more detail below in connection with FIG. 8.

Database 130 is an organized collection of data that includes database management systems that allow for manipulation of data through update and retrieval.

Client input data 131 includes project schedule activities. Each schedule activity can include one or more of an activity name, description, start date and/or time, end date and/or time, and activity identification code. Example schedule activity names include pouring concrete, welding support beams, and lifting I-beams with crane. As described in further detail below, client input data 131 can be formatted according to a file format 132 (e.g., .csv, .xls, other), or according to a database format 133 (e.g., Oracle Primavera P6 Enterprise Project Portfolio Management, Oracle Primavera P6 Professional Project Management, other).

In some exemplary embodiments, and as shown in FIG. 1, client input data 131 can be uploaded to Server 100 via client-facing Website 111. Alternatively, a user may instruct Server 100 to connect directly with a database via a web services connection to retrieve the client input data. Once the Server 100 receives the client input data, Server 100 can parse, process, and classify the client input data 131 using Activities Classifier 121. Server 100 can then integrate and schedule activities contained within client input data 131 to Database 130. Client-facing Mobile App 110 can send requests and receive responses from Server 100. Server 100 sends requests and receives responses from Hyper-local Weather Forecaster 120, Severe Weather Alert Meteorological Event Classifier 122, and Weather Forecast Meteorological Event Classifier 123. Server 100 sends data updates and receives responses from Database 130. Server 100 sends Notifications 112 to client-facing systems via mobile push notification services and email.

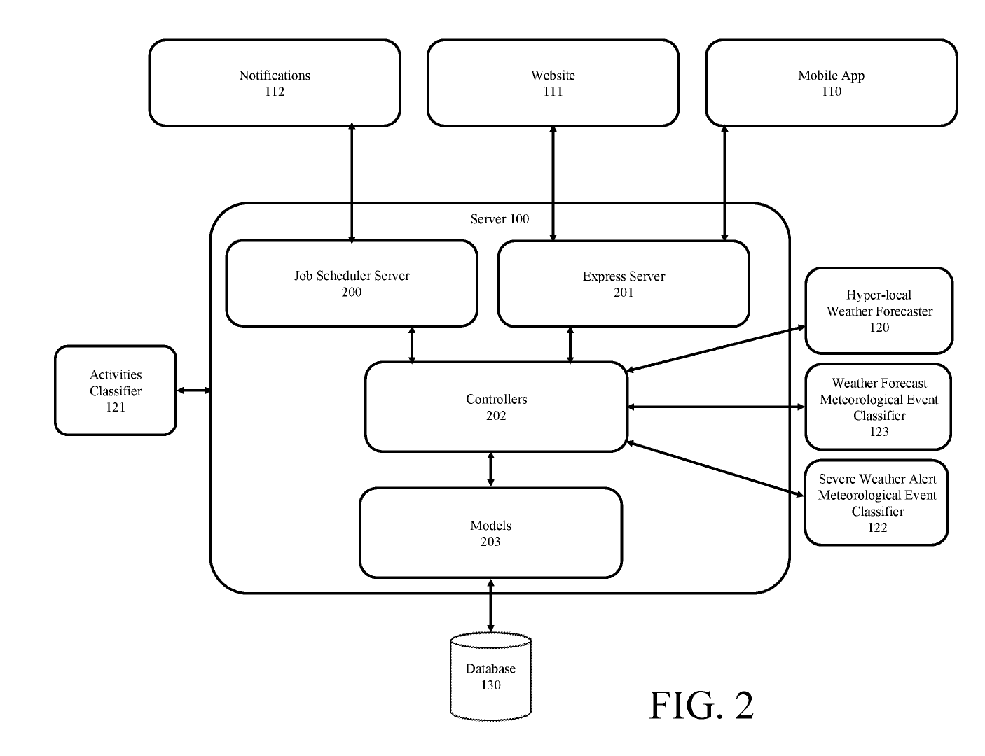

FIG. 2 illustrates the components of Server 100 in greater detail. Server 100 can comprise a Job Scheduler Server 200, an Express Server 201, Controllers 202, and Models 203. As discussed and depicted above, interacting with Server 100 components are client-facing Mobile App 110, website 111 and Notification 112; Hyper-local Weather Forecaster 120, Schedule Activities Classifier 121, Severe Weather Alert Meteorological Event Classifier 122 and Weather Forecast Meteorological Event Classifier 123; and Database 130.

Job Scheduler Server 200 is a mechanism that requests impacted schedule activities with impacting weather events from the Controllers 202 and sends notifications to client facing interfaces on a schedule, such as a 7 am daily project report that includes forecasted weather events and schedule impacts for that day. In some embodiments, Job Scheduler Server 200 can take the form of an Application Program Interface (API).

Express Server 201 provides an interface within Server 100 to handle client driven interactions between Website 111 and Mobile App 110 and the necessary controllers in Controllers 202. Unlike Job Scheduler Module 200, Express Server 201 can handle unscheduled interactions with clients via Website 111 and Mobile App 110.

Controllers 202 can provide decoupling between models and client facing views. The controller receives requests and sends responses to and from the views and handles updates and responses to and from the model and other component programs.

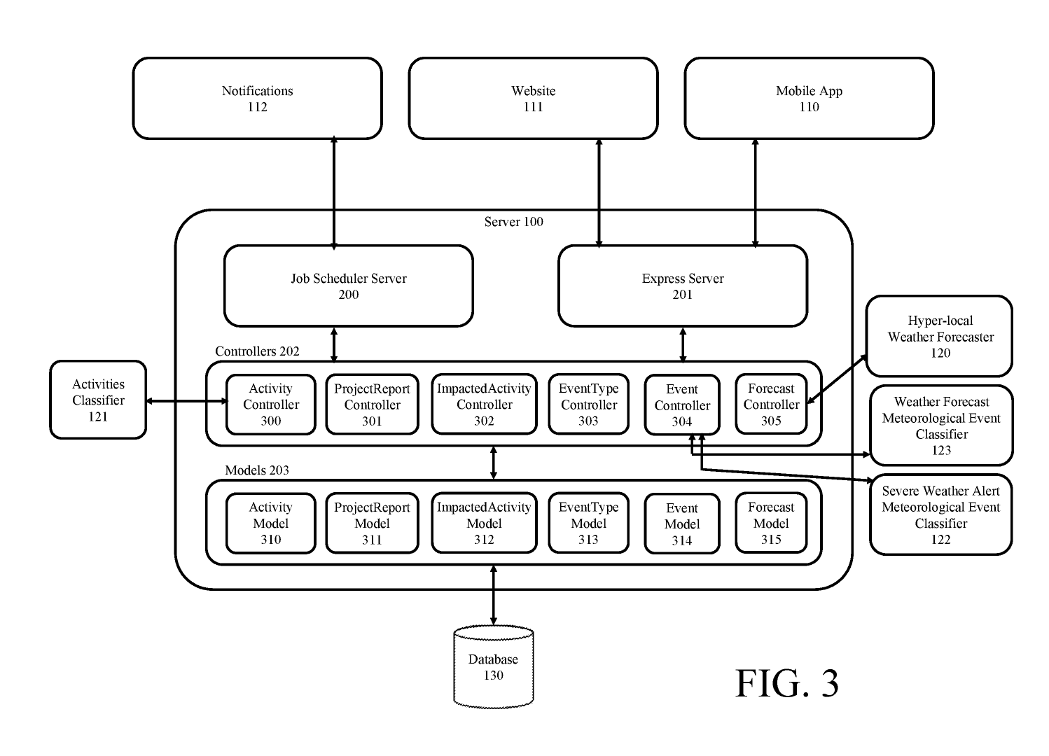

Models 203 define data types for processing and storing specific subsets of application data. For instance, Activity Model 310 (described in further detail below in FIG. 3) defines the structure and attributes, such as activity name, description, start date, and data, and identification code, for schedule activity data structuring and referencing throughout the system.

When a client interacts with Mobile App 110 and/or Website 111, Mobile App 110 and/or Website 111 can send the client's input to Express Server 201, which can route each request to the appropriate controller objects in Controllers 202. Job Scheduler Server 200 can send scheduled requests to Controllers 202. Controllers 202 receive requests from Job Scheduler Server 200 and Express Server 201, identify which model objects in Models 203 need to be updated, and send messages to the necessary model objects in Models 203 requesting updates. The necessary model objects in Models 203 react to the received messages regarding updates and apply application logic to update model properties and save or fetch data from Database 130, responding back to the necessary controller objects in Controllers 202 when the model has been updated. The Controllers 202 then respond to the Job Scheduler Server 200 or the Express Server 201 so they reflect the changes made to the Models 203, which are sent to the client-facing Mobile App 110, Website 111, or Notifications 112.

To retrieve forecast information or classify data for specific Models 203 logic and properties, Controllers 202 send requests and receive responses from the Hyper-local Weather Forecaster 120, Activities Classifier 121, Severe Weather Alert Meteorological Event Classifier 122, and Weather Forecast Meteorological Event Classifier 123.

FIG. 3 illustrates the interaction of specific server controllers and models to manage application data and logic, according to some embodiments. As described above in FIG. 2, the system can include Server 100 consisting of a Job Scheduler Server 200, an Express Server 201, Controllers 202 and Models 203. Controllers 202 can include different controllers 300-305 for different data attributes. Similarly, Models 203 can include different models 310-315 for different data attributes. Interacting with Activity Controller 300 is Activities Classifier 121; interacting with Event Controller 304 are Weather Forecast Meteorological Event Classifier 123 and Severe Weather Alert Meteorological Event Classifier 122; interacting with Forecast Controller 305 is Hyper-local Weather Forecaster 120.

Controllers 300-305 can receive requests and send responses to and from the views and component programs, and handle updates and responses to and from the corresponding models 310-315.

Each of the models 310-315 can comprise data structures that are maintained in memory and are actively operated on (e.g., created, updated, modified, processed, viewed, and/or deleted) by controllers 300-305. In addition, each of the models 310-315 can also be considered to define a separate “data type”. These “datatypes” define data structures with specific fields or components that capture the types of data described below. Therefore, Activity Model 310 can be considered to define an “Activity Model 310 datatype,” and Project Report Model 311 can be considered to define a “Project Report Model 311 datatype,” and so on. Therefore, as used herein, a “datatype” corresponding to a given model refers to a definition for a data structure used or implemented by that model.

Activity Model 310 can define specific data-type logic and attributes for processing and storing schedule activity data. Activity data attributes can include schedule activity name (e.g., pouring concrete, welding support beams, lifting I-beams with crane, etc.), description, start date, end date, and identification code.

Project Report Model 311 can define specific data-type logic and properties for processing and storing project report data. Project Report data can include start date, end date, description, weather forecast, weather events for forecast, impacted schedule activities by weather events, and project report URL. Project Report Model 311 can be configured to generate, modify, categorize, produce, use, or store project reports and/or updates based on the aforementioned data. These reports can be requested by a customer via Express Server 201, for example, or sent to a customer as part of a regular scheduled report via Job Scheduler Server 200.

Impacted Activity Model 312 can define specific data-type logic and properties for processing and storing impacted activity data. Impacted activity data includes a schedule activity, the weather event types impacting the activity, start date, and end date. For example, impacted activity data can indicate that an activity (e.g., lifting I-beams with crane) scheduled for a certain start date/time and end date/time may be impacted by certain forecasted weather events (e.g., high winds, sleet, or fog).

Event Type Model 313 can define specific data-type logic and properties for processing and storing weather event type data. Weather event type data includes defined data structures that specify the differentiation between the various types of weather events (e.g., rain event type, snow event type, hail event type) and include an identifier integer that corresponds to a specific weather event type (e.g., 1 for rain, 2 for snow, 3 for hail), title (e.g., rain, snow, hail), and description.

Event Model 314 can define specific data-type logic and properties for processing and storing weather event data. Weather event data includes attributes of a specific weather event such as the corresponding time-series weather forecast that was used to derive the weather event, the weather event's weather event type, start date/time, duration, intensity, probability of occurring, and the schedule activities impacted by the weather event.

Forecast Model 315 can define logic and properties for processing and storing forecast data. Forecast data includes attributes ingested from Hyper-Local Weather Forecaster 120 for a given latitude, longitude, and duration that may include air quality index, apparent temperature, apparent temperature maximum, apparent temperature maximum time, apparent temperature minimum, apparent temperature minimum time, cloud cover, dew point, humidity, lightning, nearest storm bearing, nearest storm distance, ozone, precipitation accumulation, precipitation intensity, precipitation intensity maximum, precipitation intensity maximum time, precipitation probability, precipitation type, pressure, temperature maximum, temperature maximum time, temperature minimum, temperature minimum time, UV index, valid time, visibility, weather summary, wind bearing, wind gust, wind speed, and severe weather alert texts.

The use of different types of pre-defined models and/or data types facilitates the systematic parsing, processing, and manipulation of data in a way that exploits the efficiencies of machine learning, as described in greater detail below. For example, the Activity Model 310 defines a standard format for describing schedule activities received from clients. Since data received from clients may come in many different types of formats, the standard format defined by Activity Model 310 allows for a uniform and consistent way to express schedule activity data. This in turn allows Activity Classifier 121 (described in greater detail below) to apply the machine-learning techniques described herein to predict what types of weather events are likely to impact a particular schedule activity. Similarly, data received from Hyper-local Weather Forecaster 120 may come in many different types of formats. As described in greater detail below, Event Type Model 314 defines a uniform and consistent format for describing weather events. This in turn allows Severe Weather Alert Meteorological Event Classifier 122 and Weather Forecast Meteorological Event Classifier 123 to extract specified types of weather events from data received from Hyper-local Weather Forecaster 120 using the machine-learning techniques described herein. This uniform format also allows for the matching of predicted weather events against schedule activities.

Client interaction with Mobile App 110 and Website 111 can cause requests to be sent to Express Server 201 which can route each request to the appropriate controller objects in Controllers 202. Job Scheduler Server 200 sends scheduled requests to Controllers 202. Controllers 202 receive requests from Job Scheduler Server 200 and Express Server 201.

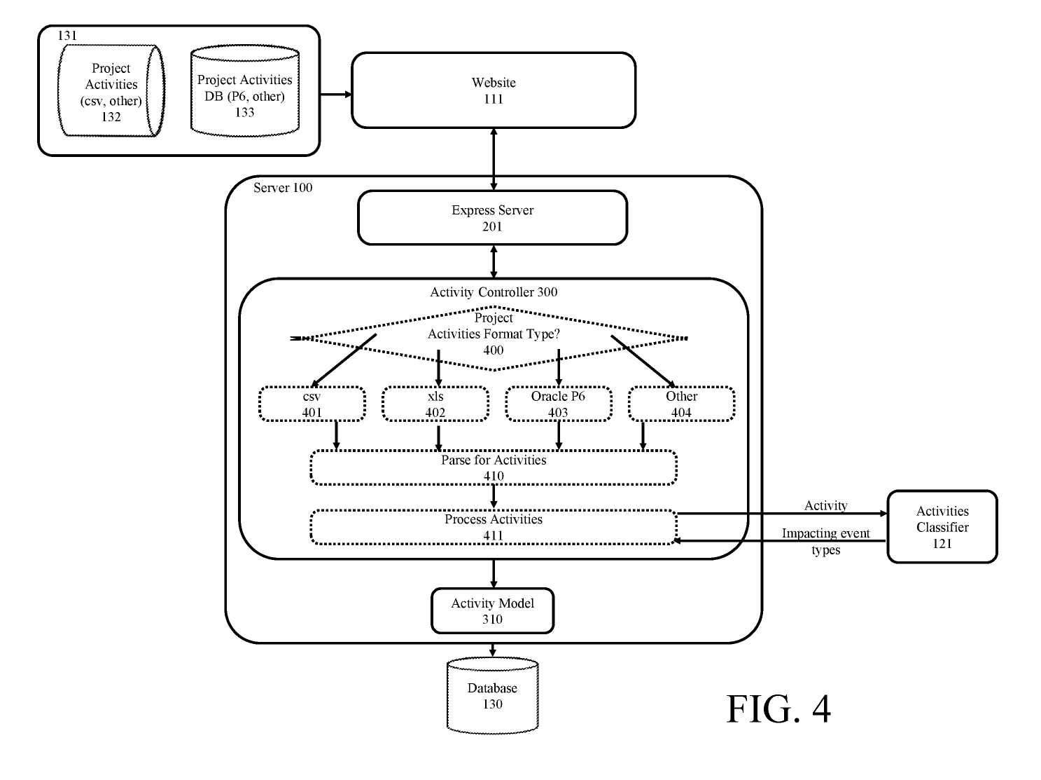

Activity Controller 300 can receive requests from Express Server 201 to parse, process, and extract relevant attributes for schedule activities imported to Server 100, either via website 111 or through a direct connection to a client's database. Activity Controller 300 sends requests containing the schedule activities to Activities Classifier 121. Activity Controller 300 then receives a response with impacting weather event types, such as rain, wind, snow, and lightning, for each activity. Activities Controller 300 can also update activities in Activity Model 310, and store them in Database 130. This feature is described in more detail below in connection with FIG. 4.

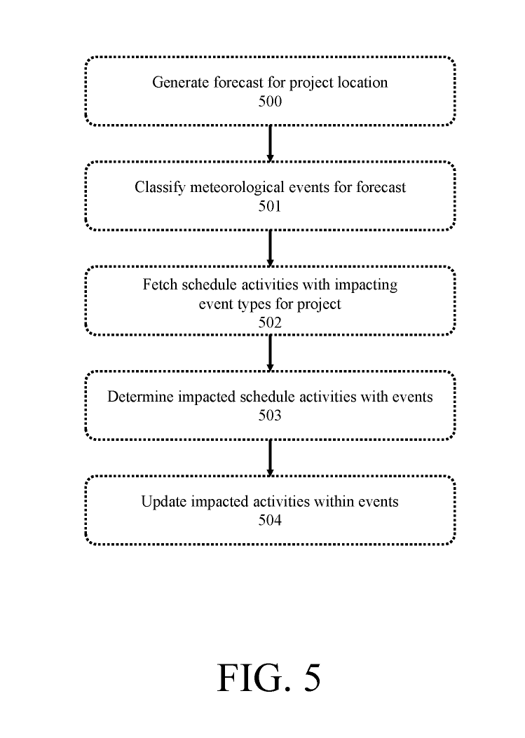

Project Report Controller 301 can receive request from either Job Scheduler Server 200 or Express Server 201 to generate a project report of type Project Report Model 311 to return as either a notification in Notifications 112, or to client facing Website 111 or Mobile App 110, through the respective server. This feature is described in more detail below in connection with FIG. 5.

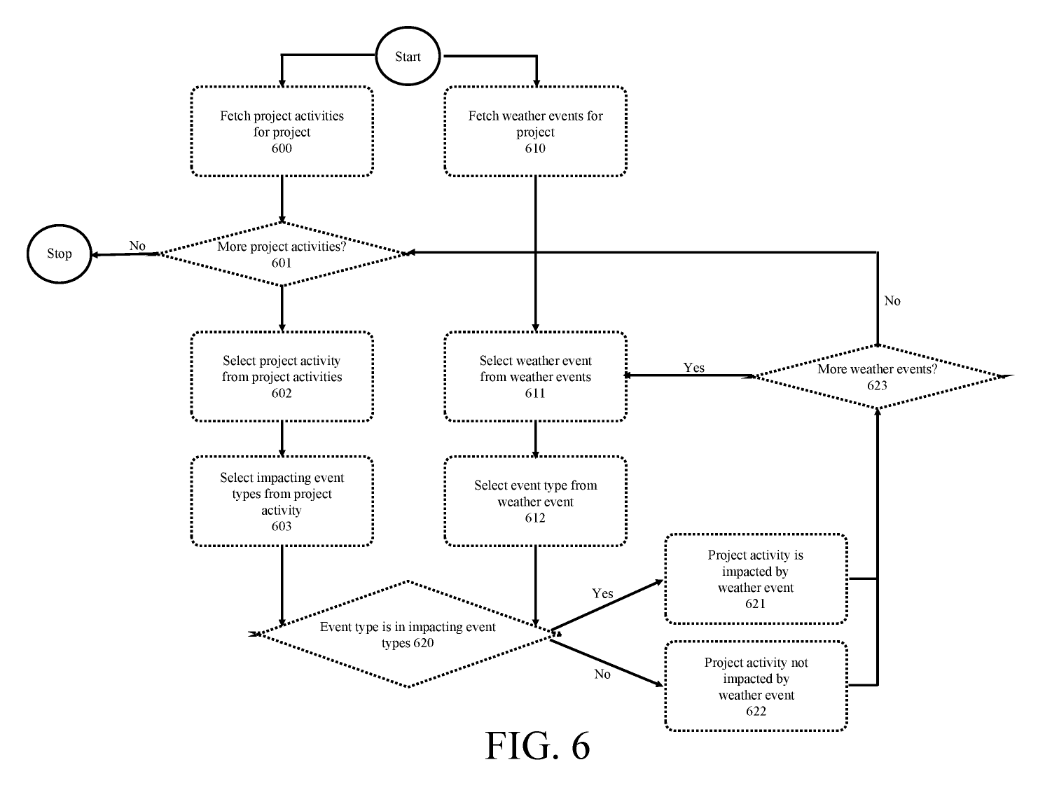

Impacted Activity Controller 302 can receive requests from Project Report Controller 301 to determine and return impacted schedule activities by meteorological events. This feature is described in more detail below in connection with FIG. 6.

Event Controller 304 can receive requests from Forecast Controller 305 to determine meteorological events of data-type Event Model 314 from forecasts of data-type Forecast Model 315. In response, Event Controller 304 can send requests with forecasts of type Forecast Model 315 to Severe Weather Alert Meteorological Event Classifier 122 and Weather Forecast Meteorological Event Classifier 123. Each can then return meteorological events, of type Event Model 314, for the forecasts in the requests.

Forecast Controller 305 can receive requests from Project Report Controller 301 to generate a forecast of type Forecast Model 315 for a project location and timeframe. To help complete the request from Project Report Controller 301, Forecast Controller 305 can send a request to Hyper-local Weather Forecaster 120 to receive a time-series weather forecast.

FIG. 4 illustrates exemplary system and methods for uploading schedule activities and classifying impacting meteorological event types, according to some embodiments. The system can take as input client input data 131 consisting of file-based schedule activities 132 and/or database schedule activities 133. As described above, the exemplary system can also comprise client facing Website 111, Server 100 consisting of Express Server 201, Activity Model 310, Activity Controller 300 which implements various processes, Database 130, and Activities Classifier 121. The processes implemented by Activity Controller 300 can include: a step 400 for determining the format of the input schedule activities, which can result in determining what format the input schedule activities were formatted in, a step 410 for parsing the input file for activities, and a step 411 for processing activities.

For example, Activity Controller 300 may determine at step 400 that client input data 131 has been formatted according to a file-based format. This file-based format may be or include a generic file format used to store any type of data, including but not limited to schedule data. For instance, examples of generic file formats include but are not limited to: a Microsoft Project (MPP) format type, a Microsoft Excel (XLS or XLSX) format type, a Comma-Separated Value (CSV) format type, a Tab-Separated Values (TSV) format type, an architecture-engineering-construction Extensible Markup Language (aecXML) format type, and a JavaScript Object Notification (JSON format type). This file-based format may also be or include construction and/or maintenance-industry standard formats that are generally used to store schedule or project activity data. Examples of such industry-standard formats include but are not limited to a Building Information Modeling (BIM) format type, a National BIM Standard-United States (NBIMS-US) format type, an Industry Foundation Class (IFC) format type (International Standard ISO 16739:2013), and a Construction-Operations Building information exchange (COBie) format type. The file-based format may also be and/or include a database-specific format, such as but not limited to an Oracle Primavera (XER) format type, a Deltek Open Plan format type, a Deltek Acumen format type, an SAP Work Order (SCM-ICH-WO) format type, an IBM Maximo format type, an Elecosoft Asta Powerproject (PP) format type, a Trimble Vico Schedule Planner format type, a Trimble Tilos Linear Project format type, a Trimble Tekla Task Manager format type, a Trimble LeanSight format type, an Autodesk BIM 360 format type, and a PMA Technologies NetPoint (.NP4, .NPT) format type.

Activity controller 300 may also determine at step 400 that client input data 131 has been formatted according to a database-format. Data formatted according to a database-format are generally not uploaded to Server 100 in files, but are uploaded via a direct database-to-database web services connection to another database, such as a database maintained or operated by a client. Examples of a database format include but are not limited to an Oracle database format, an IBM DB2 database format, a Microsoft SQL database format, a MySQL database format, a NoSQL database format, and a NewSQL database format.

For ease of explication and without limiting any of the foregoing, FIG. 4 depicts the following, non-exhaustive format types: csv 401, xls 402, Oracle P6 403, and other 404.

csv 401 is defined as the comma separated value text file type.

xls 402 is defined as the .xls Microsoft Excel compatible file type.

Oracle P6 403 is defined as the Oracle Primavera P6 Enterprise Project Portfolio Management and/or Oracle Primavera P6 Professional Project Management scheduling database type.

Other 404 defines any other file or database type.

At step 410, Activity Controller 300 determines individual schedule activities and their corresponding attributes from the imported file or database in client input data 131. Since client input data 131 may comprise data pertaining to multiple schedule activities, the process at step 410 may first comprise parsing out each individual schedule activity within client input data 131. This process may also involve extracting relevant attributes from each parsed schedule activity. These relevant attributes may include (but are not limited to) the following:

(i) Activity ID: this may comprise the unique identifier of an activity assigned by a scheduling software in order to identify and track activities.
(ii) Activity Code: this may comprise a code, defined according to an industry or client-specific standard, that is used to categorize activities
(iii) Activity Name: this may comprise a short name, phrase, or title that describes the activity.
(iv) Activity Description: This may comprise a detailed description of the activity. The description provides additional information to supplement the short names or titles of the Activity Name, and may give background information or establish a purpose for the activity. The detailed description may help to differentiate between activities with similar names, which are useful in multi-user environments with multi-party communication and collaboration.
(v) Activity Start: This may comprise the start date of an activity. This may include a time of day, depending on the level of detail. In some embodiments, there may be multiple start dates, such as an optimistic, expected, pessimistic, or actual start date.
(vi) Activity Finish: This may comprise the finish date of an activity. This may include a time of day, depending on the level of detail. In some embodiments, there may be multiple end dates, such as an optimistic, expected, pessimistic, or actual end date.

At step 411, Activity Controller 300 structures activity attributes to format activity data according to the attributes defined by Activity Model 310. In some embodiments, this formatting can include instantiating a new Activity Model 310 for each schedule activity, wherein the newly instantiated Activity Model 310 includes the extracted attributes pertaining to that schedule activity. Activity Controller 300 can also determine, by communicating with Activities Classifier 121, the set of impacting meteorological event types of data-type Event Type Model 313 that may impact each schedule activity.

According to some embodiments, client project schedule activity data 131, either of type file 132 or database 133, is uploaded to Server 100 via client facing Website 111 or via a direct database-to-database connection. The uploaded client project schedule activity data 131 is sent to Express Server 201, which sends a request to Activity Controller 300 to integrate the schedule activities to type Activity Model 310. Activity Controller 300 determines the format type 400 of the input schedule activities, e.g., either csv 401, xls 402, Oracle P6 403, or another format type 404. The resulting unstructured data is parsed at step 410 for individual activities and their corresponding attributes. The activities are processed at step 411 to fit the Activity Model 310 structure, which includes sending a request to Activities Classifier 121 to classify and return impacting event types for each processed activity. Activity Controller 300 then updates Activity Model 310 for each processed activity, and stores the processed activities, each of type Activity Model 310, to Database 130.

FIG. 5 illustrates an exemplary process implemented by the ProjectReport Controller 301 for classifying meteorological events from a forecast and determining impacted schedule activities, according to some embodiments. This process includes generating forecast data at step 500, classifying meteorological events for forecast at step 501, fetching schedule activities with impacting event types at step 502, determining impacted schedule activities by meteorological events at step 503 (see FIG. 6 for logic) and updating impacted activities within corresponding events at step 504.

Forecast generation 500 is a process that sends a request to Forecast Controller 305 to generate and return a forecast of data-type Forecast Model 315 at the project latitude & longitude for the needed timeframe.

Meteorological events classification for forecast 501 is a process that sends a request to Event Controller 304 to classify and return weather events, each of data-type Event Model 314 (and thus structured according to the attributes defined by Event Model 314) given the project, forecast, and timeframe.

Fetching schedule activities with impacting event types for project 502 is a process that sends a request to Activity Controller 300 to return activities that are scheduled for the relevant time period and the relevant project of the requested report. The returned activities may be of type Activity Model 310, and each returned activity may include the types of weather events which may impact that activity, wherein each included weather event is of type Event Type Model 313.

Determination of impacted schedule activities by events 503 is a process that sends a request to Impacted Activity Controller 302 to determine and return those activities (of type Activity Model 310) returned in step 502 which may be impacted by the forecasted weather events (of type Event Model 314) generated in step 501.

Update impacted activities within events 504 is a process of updating the impacted activities for the corresponding impacting events to indicate that they may be impacted by the determined, forecasted weather events of type Event Model 314.

According to some embodiments, Project Report Controller 301 receives a request to generate a project report of type Project Report Model 311. In response, Project Report Controller 301 may determine potential impacts to scheduled activities by forecasted meteorological events in order to complete Project Report Model 311. In some exemplary processes, first, Project Report Controller 301 generates (or, in some embodiments, requests and receives) a forecast for a given project location and timeframe (process 500) from Forecast Controller 305—Project Report Controller 301 may also update Forecast Model 315. Project Report Controller 301 then sends a request with the generated forecast to Event Controller 304 to classify and return weather events 501, each of type Event Model 314, for the forecast. Project Report Controller 301 then sends a request to Activity Controller 300 to return scheduled activities for the relevant time period and project, wherein each returned schedule activities include event types that may impact that activity (process 502). Project Report Controller 301 then determines those scheduled activities that may be impacted by the forecasted meteorological events (process 503). This may be accomplished through a matching process described in more detail below in connection with FIG. 6. Finally, Project Report Controller 301 sends a request to Event Controller 304 to update Event Model 314 with the impacted schedule activities for the corresponding impacting events to indicate that certain schedule activities may be impacted by the forecasted weather events.

FIG. 6 illustrates an exemplary process implemented by the ImpactedActivity Controller 305 for matching schedule activity impacting event types and meteorological events to determine schedule activity impacts, according to some embodiments. The logic processes include receiving schedule activities for project 600, selecting a schedule activity 602 if there are more unprocessed schedule activities 601, and selecting the impacting event types from the selected schedule activity 603. In parallel, meteorological events are received for the project 610, a meteorological event is selected from meteorological events 611, and the meteorological event type is selected 612. If the event type of the meteorological event is in the impacting event types of the schedule activity 620, the schedule activity is impacted by the meteorological event 621, else the schedule activity is not impacted by the meteorological event 622. This process continues for all remaining meteorological events 623, and all remaining schedule activities 600.

Fetching schedule activities for project 600 is the process of receiving a list or queue of schedule activities, each of type Activity Model 310, from Project Report Controller 301.

More schedule activities decision 601 is the process of deciding if there are additional schedule activities that have not been processed from the list or queue of schedule activities fetched as part of process 600.

Schedule activity selection from schedule activities 602 is the process of reading the next non-processed activity of data-type Activity Model 310 from the queue of activities.

Impacting event types selection from schedule activity 603 is the process of reading a list of weather event types (of data-type Event Type Model 313) that may impact the type of activity selected/read as part of process 602. These impacting weather event types may be listed as a property of the selected/read activity from process 602, which is of data-type Activity Model 310.

Fetching meteorological events for project 610 is the process of receiving a list or queue of meteorological events, each of data-type Event Model 314, from Project Report Controller 301.

Meteorological event selection from meteorological events 611 is the process of reading the next event of data-type Event Model 314 from the queue of events fetched in process 610.

Meteorological event type selection from meteorological event 612 is the process of reading the meteorological event type (a data structure of type Event Type Model 313) from the selected event in process 611, which is of type Event Model 314.

Meteorological event type is in impacting event types decision 620 is the process of determining if the meteorological event type determined in step 612 (e.g., rain, snow, wind, and lightning) impacts the activity currently being considered in processes 602 and 603. This can be done by comparing the meteorological event type determined in step 612 with the list of impacting weather event types generated in step 603. If there is a match, then the process branches to process 621, which determines that the scheduled activity under consideration at step 602 may be impacted by the meteorological event selected at process 612. If not, the process branches to process 622, which determines that the scheduled activity under consideration at step 602 would probably not be impacted by the meteorological event selected at process 612.

Unprocessed meteorological events decision 623 is the process of deciding if there are additional meteorological events that have not been processed. If unprocessed events remain, the next unprocessed meteorological event is selected 611. If not, the process branches to 600, where the next project activity is fetched.

According to some embodiments, Impacted Activity Controller 302 receives a list or queue of schedule activities for the project (process step 600), each of type Activity Model 310, and a list or queue of meteorological events for the project (process step 610), each of type Event Model 314, from Project Report Controller 301. If unprocessed schedule activities exist in the list of schedule activities received at process step 600, an individual unprocessed schedule activity is selected (process step 602); otherwise 601 the process concludes. An array of potential impacting weather event types (each of type Event Type Model 313), each of which are likely to impact the selected schedule activity if they were forecasted to occur, is determined from the chosen schedule activity (process step 603).

In parallel, given the list of meteorological events from 610, an individual meteorological event is selected (process step 611). The meteorological event's event type (wherein the event type is of Event Type Model 313) is determined from the selected individual meteorological event (process step 612).

In process step 620, if the selected event type (from step 612) is in the array of impacting event types for the schedule activity (from step 603), the system concludes that the scheduled activity may be impacted by the corresponding forecasted meteorological event (step 621); otherwise the system concludes that the scheduled activity will likely not be impacted by the corresponding forecasted meteorological event (step 622). At step 623, the system determines whether there are any additional meteorological events to process from the list of weather events fetched at step 610. If all meteorological events have been processed with the selected schedule activity, the next schedule activity is selected for matching 600. Otherwise 623 the next unprocessed meteorological event is selected (step 611) for processing.

The process continues until no more unprocessed activities remain, at which point decision 601 concludes the cycle and Impacted Activity Controller 302 returns impacted schedule activities by meteorological events to Project Report Controller 301.

FIG. 7 illustrates an embodiment of the system and methods for creating and maintaining a classifier in disk memory for meteorological events classification from severe weather alert text. As discussed above, severe weather alert text comprises text alerts written at least in part by human meteorologists and issued by weather forecast authorities or sources, such as the National Weather Service (NWS) and the UK Met Office Severe Weather Warning system. As described above, the system includes Server 100 and Severe Weather Alert Meteorological Event Classifier 122. The Severe Weather Alert Meteorological Event Classifier 122 may comprise at least one jQuery HTML Scraper 701 (processes described below), National Weather Service (NWS) products listing database 706, NWS alerts text file 707, binary target attribute tagging process 708, training data 709, Multi-label Classifier 710 (processes described below), and Multi-label (ML) model 720. jQuery HTML scraper 701 implements a process for collecting training data, which includes requesting NWS URL 702, parsing returned HTML and requesting NWS URL with appended NWS state location code 703, parsing returned HTML and requesting URL appended with NWS directory file name 704, parsing returned html and writing to a file 705 (e.g., a text or csv file). Multi-label Classifier 710 implements a process for training and saving a machine learning model, which includes loading training data 711, performing binary relevance learning method one-vs-all algorithm 712, and persisting the trained model 713.

jQuery HTML Scraper 701 is an object that performs automatic collection of existing NWS severe weather alerts text from NWS servers. According to some embodiments, Scraper 701 may implement process steps 702, 703, 704, and/or 705 described below.

NWS products listing database 706 is a manually accessed database for collection of NWS alerts text.

NWS alerts text file 707 is a collection of aggregate NWS alerts text.

Binary target attribute tagging process 708 is the process of manually and automatically tagging each NWS alert with its known target attributes.

Training data 709 is a collection of known NWS alert text inputs and known meteorological event type outputs. A detailed example of training data 709 is described below in relation to FIG. 12.

Multi-label Classifier 710 is the object that finds patterns in the Training data 709 that map the input NWS alert Text to known meteorological event types. According to some embodiments, Multi-label Classifier 710 may implement process steps 711, 712 and 713, described below.

ML model 720 is the object resulting from the training process that can produce classifications on data with unknown output values.

FIG. 7 includes the machine learning processes of collecting NWS alerts text data 707 using jQuery HTML Scraper 701 and NWS products listing database 706, formatting and structuring training data 709 using binary target attribute tagging 708, and training machine learning model 720 using Multi-label Classifier 710. Machine learning model 720 receives requests containing NWS alert text from Server 100 and returns meteorological event types to Server 100.

In some embodiments, at process step 702, jQuery HTML Scraper 701 accesses warnings for each of multiple NWS directory codes, which are accessible, for example, using URLs to public websites maintained and updated by weather forecasters, such as the National Weather Service (NWS). At process step 703, jQuery HTML Scraper 701 parses the returned HTML code using j Query methodology to categorize received weather warnings according to location. For instance, jQuery HTML Scraper 701 can parse the received HTML code using “href” attributes that specify a NWS state location code. At process step 704, jQuery HTML Scraper 701 parses the returned HTML code to categorize the received weather warnings according to type. For instance, jQuery HTML Scraper 701 can parse the received HTML code using “href” attributes that specify different NWS directory file names where the NWS alert text resides. At process step 705, the parsed HTML code is written to an output file in text format, such as to a CSV file. This CSV file can correspond to NWS alerts text (CSV) 707.

As discussed above, Multi-label Classifier 710 is the component that maps weather alert text (received, for example, from weather authorities such as the National Weather Service (NWS) and the UK Met Office Severe Weather Warning system) to known meteorological event types of data type EventType Model 313. Multi-label Classifier 710 may implement exemplary process steps 711, 712, and 713. At process step 711, Multi-label Classifier 710 receives training data 709 and loads training data 711. This loading process may also include formatting and verifying the training data 709 contents. At step 712, Multi-label Classifier 710 applies a binary relevance learning method one-vs-all algorithm. This algorithm comprises fitting one support vector machine (SVM) classifier per class, such as rain, snow, wind, and lightning, to map patterns between historical severe weather alert text and known corresponding weather events provided in the training data 709. Each SVM is fit, or learns, from the training data by mapping the training data points to image points in an internal feature space. Next, the internal training points are used to compute the locations and orientations of a pair of parallel support hyperplanes in the internal feature space that optimally differentiate between the two classes of points by a margin consisting of the region between the two support hyperplanes. Then, a decision hyperplane is defined as the central plane between the two support hyperplanes and the SVM's classifying function is defined to return +1 for external data points whose internal images lie on one side of the decision hyperplane and −1 those whose images lie on the other side. That is, to classify any feature vector, the SVM simply maps it to its image in the internal feature space and then checks which side of the decision hyperplane it lies on. The mappings form a trained machine learning model. At step 713, this trained machine learning model is persisted as ML Model 720, and this trained machine learning model can provide predictions for each of the classes given severe weather alert text. For example, Server 100 can send requests containing NWS severe weather alert text to ML Model 720, which can produce and return meteorological event type predictions (e.g., events of data-type Event Type Model 313) based on the received NWS alert text.

FIG. 8 illustrates an embodiment of a system and methods for creating and persisting a classifier for meteorological events classification from time series weather forecasts. This system and these methods are similar to those discussed above for FIG. 7, except that this system and these methods are for classifying time series weather forecasts instead of alert text. The system includes Server 100, Database 130, and Weather Forecast Meteorological Event Classifier 123. Weather Forecast Meteorological Event Classifier 123 may comprise or implement memory storing time-series weather forecasts 801, algorithmic target attribute tagging processes 802, training data 803, Multi-label Classifier 804 (processes described below), and ML model 820. Multi-label Classifier 804 includes the processes of loading training data 805, performing binary relevance learning method one-vs-all algorithm 806, and persisting the trained model 807.

Time-series weather forecasts 801 is a collection of aggregate time-series forecast data. Algorithmic target attribute tagging process 802 is the process of automatically collecting training data that includes matching time-series weather forecasts with target weather events. The target weather events are algorithmically determined for each weather forecast using industry standard and/or user defined weather threshold criteria (e.g., wind speed greater than 25 mph denotes a wind event). For example, a time-series weather forecast where wind speed exceeds the industry standard threshold of 25 mph would be tagged with a wind event. These known weather forecast and weather event matches allow Multi-label Classifier 804 to map patterns between these known connections and use the patterns to predict weather events for a given weather forecast.

Training data 803 is a collection of known forecast inputs and known meteorological event type outputs.

Multi-label Classifier 804 is a component that finds patterns in the training data 803 to facilitate mapping the input forecasts to known meteorological event types. Multi-label Classifier 804 can implement process steps 805, 806, and/or 807, described below.

ML model 820 is the object resulting from the training process that can produce classifications on data with unknown output values.

FIG. 8 includes the machine learning processes of collecting time series weather forecasts 801 from Database 130, algorithmic target attribute tagging 803 of unstructured forecasts 801 to create training data 803, and training machine learning model 820 using Multi-label Classifier 804.

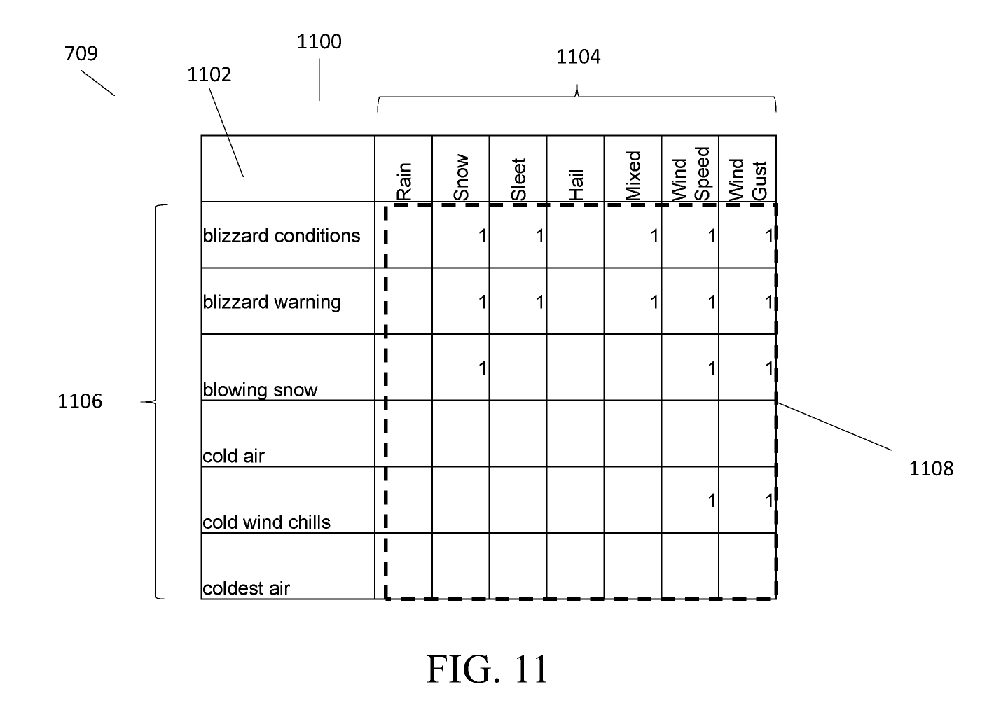

At process step 805, Multi-label Classifier 804 receives and loads training data 803, which may include formatting and verifying the training data 803 contents. In some embodiments, the training data may comprise a two dimensional matrix with M rows and N columns. Each row may correspond to a separate weather forecast attribute derived from time series weather data, and each column may correspond to a meteorological event type (e.g., a separate event type of data type EventType 313). Within this two dimensional matrix, each element [m, n] (where 0≤m≤M, and 0≤n≤N) may equal 1 if the weather forecast attribute corresponding to row m was observed for a weather event of event type n, or may equal 0 if the weather forecast attribute corresponding to row m was not observed for a weather event of event type n. This feature is described in more detail below in connection with FIG. 11.

At process step 806, a binary relevance learning method one-vs-all algorithm is applied to the training data. This algorithm may comprise fitting one support vector machine (SVM) classifier per class, such as rain, snow, wind, and lightning, to map patterns between historical forecasts and known corresponding weather events provided in the training data 803. Each SVM is fit, or learns, from the training data by mapping the training data points to image points in an internal feature space. Next, the internal training points are used to compute the locations and orientations of a pair of parallel support hyperplanes in the internal feature space that optimally differentiate between the two classes of points by a margin consisting of the region between the two support hyperplanes. Then, a decision hyperplane is defined as the central plane between the two support hyperplanes and the SVM's classifying function is defined to return +1 for external data points whose internal images lie on one side of the decision hyperplane and −1 those whose images lie on the other side. That is, to classify any feature vector, the SVM simply maps it to its image in the internal feature space and then checks which side of the decision hyperplane it lies on. The mappings derived from step 806 form a trained machine learning model. At step 807, this trained machine learning model is persisted as ML Model 820—this ML Model 820 can be used to provide predictions for each of the classes given a time-series weather forecast. Server 100 sends requests containing time series weather forecast to ML Model 820, which produces and returns meteorological event type predictions on the received forecast.

FIG. 9 illustrates a system and methods for creating and persisting a classifier for project activity impacting weather event types from project activity attributes. Essentially, the system and methods depicted in FIG. 9 can be used to train and maintain a classifier that returns, for a given project activity, the types of weather events that are likely to impact that given project activity. The system includes Server 100 and Activities Classifier 121 consisting of schedule activities file 901, target attribute tagging processes 902, training data 903, Multi-label Classifier 904, and ML model 920. Multi-label Classifier 904 includes the processes of loading training data 905, performing binary relevance learning method one-vs-all algorithm 906, and persisting the trained model 907.

Project activities text file 901 is a collection of aggregate project schedule activities. As described in the title, this file may comprise plain text that describes project schedule activities.

Target attribute tagging process 902 is the process of tagging each schedule activity with its known target attributes. Tagging includes the use of industry standards to determine the types of weather events (known target attributes) that are likely to impact the given project schedule activity. For example, in the construction industry and built environment, given that industry standards encourage sensitivity around crane-based project activities and wind speeds, any project schedule activity that may include the use of a crane is tagged as likely to be impacted by a wind event.

Training data 903 is a collection of known schedule activity inputs and known meteorological event type outputs.

Multi-label Classifier 904 is a component that finds patterns in the training data 903 to facilitate mapping the input forecasts to known meteorological event types.

Loading training data 905 is the process of receiving, formatting, and verifying the training data contents. Training data is of two dimensional matrix form of size m samples (activity attributes text) by n labels (meteorological event types) with element [m,n] equal 1 if sample m has target label n and 0 otherwise.

Performing binary relevance learning method one-vs-all algorithm 906 is the process of fitting one support vector classifier with linear kernel per class which is used to predict multiple labels.

Persisting the trained model 907 is the process of persisting and hosting the result of the training for classification services.

ML model 920 is the object resulting from the training process that can produce classifications on data with unknown output values.

FIG. 9 includes the machine learning processes of collecting project schedule activities 901, manual target attribute tagging 902 of unstructured activities 901 to create training data 903, and training machine learning model 920 using Multi-label Classifier 904.

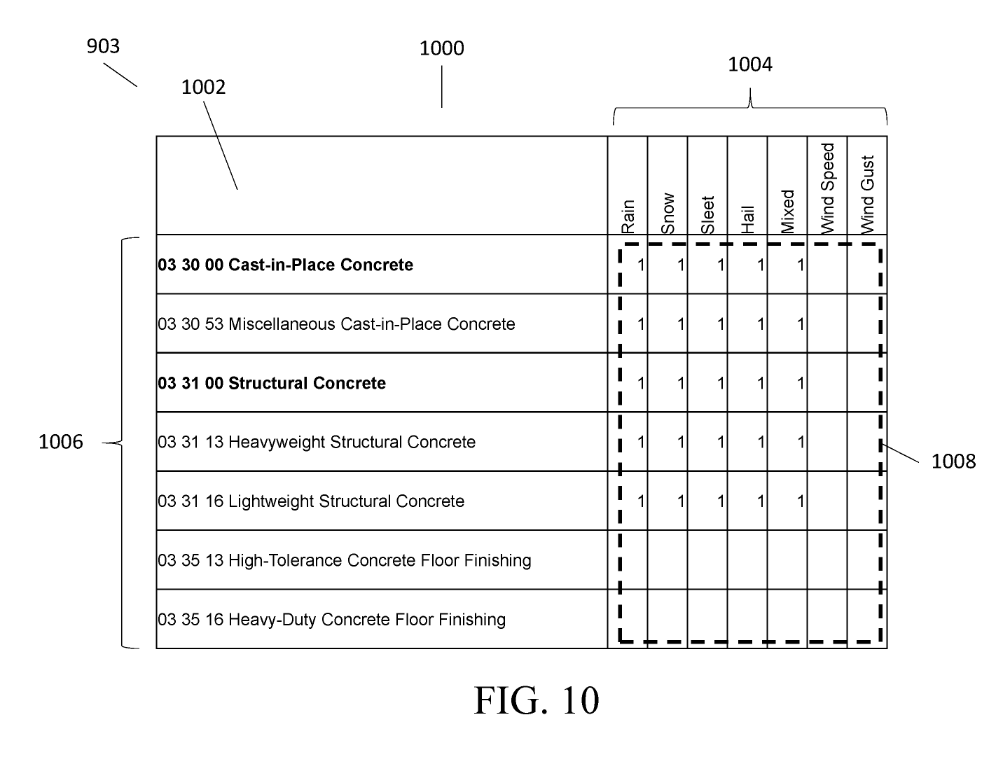

Multi-label Classifier 904 implements exemplary process steps 905, 906, and/or 907. At step 905, Multi-label Classifier 904 receives and loads training data 903—this process may also include formatting, and verifying the training data 903 contents. A detailed example of training data 903 is discussed in further detail below in relation to FIG. 10. At step 906, Multi-label Classifier 904 applies a binary relevance learning method one-vs-all algorithm to the training data. This algorithm may comprise fitting one support vector machine (SVM) classifier per class, such as rain, snow, wind, and lightning, to map patterns between historical schedule activities and known corresponding impacting weather events provided in the training data 903. Each SVM is fit, or learns, from the training data by mapping the training data points to image points in an internal feature space. Next, the internal training points are used to compute the locations and orientations of a pair of parallel support hyperplanes in the internal feature space that optimally differentiate between the two classes of points by a margin consisting of the region between the two support hyperplanes. Then, a decision hyperplane is defined as the central plane between the two support hyperplanes and the SVM's classifying function is defined to return +1 for external data points whose internal images lie on one side of the decision hyperplane and −1 those whose images lie on the other side. That is, to classify any feature vector, the SVM simply maps it to its image in the internal feature space and then checks which side of the decision hyperplane it lies on. The mappings derived from step 906 form a trained machine learning model. At process step 907, these mappings are persisted as ML Model 920, which can provide predictions for each of the classes given a schedule activity. Server 100 sends requests containing project schedule activities to ML Model 920, which produces and returns meteorological event type predictions on the received activities.

The machine learning functionality described above for FIGS. 7-9 can be implemented through several techniques. Machine learning techniques and machine learning (ML) models are used to process input datasets of activities and generate predictions. For instance, the Severe Weather Alert Meteorological Event Classifier 122 described in FIG. 7 processes input comprising severe weather alert text, and provides predictions regarding what weather events may be indicated by the severe weather alert text. The Weather Forecast Meteorological Event Classifier 123 described in FIG. 8 processes input comprising time-series weather forecasts, and provides predictions regarding what weather events may be indicated by the time-series forecast data. And the Activities Classifier 121 described in FIG. 9 processes input comprising client-provided project activities, and provides predictions regarding which weather events are likely to impact individual project activities. These predictions may include the statistical probability that a specific schedule activity may be impacted by one or many weather events. The probabilities describing the risk of specific activities being impacted can dynamically change and update as the machine learning algorithm receives new information, such as input datasets of activities or new weather event information, without requiring intervention by the user. Machine learning models generate predictions with machine learning techniques of numeric regression, based on a set of features or predictors.

In general, Activities Classifier 121 takes into account multiple factors when determining the probability describing the risk of specific activities being impacted by weather events. Relevant features or predictors influencing the probability of impacted activities include: geo-location of a given project or program, latitude and longitude coordinates of the schedule activity, time of the day, day of the month, month in the year, season in the year, and data elements related to each activity, such as activity type, activity % complete, actual finish date, actual start date, assignment, category, code, delivery type, description, duration, duration % complete, duration % of planned, duration percent, early finish date, early start date, equipment required by activity, finish date, float, float path, float path order, free float, identifier, identifier prefix, identifier suffix, impact threshold, labor, lag, late finish date, late start date, material, most likely duration, must finish by, name, out of sequence activities, parent resource, pending tasks, planned duration, planned finish date, planned start date, post-response pessimistic finish date, post-response pessimistic start date, pre-response pessimistic finish date, priority, probability (post-mitigated thresholds), probability (pre-response thresholds), probability threshold, process, remaining duration, resource, resource code, resource identifier, resource identifier name, resource type, resume date, risk, risk score, risk scoring matrix, scoring matrix, severity, start date, status, steps, suspend date, tasks, type, work breakdown structure, work breakdown structure category, work breakdown structure code, work breakdown structure identifier, work breakdown structure path, workflow, and many other relevant factors appreciated by persons with skill in the art.

Machine learning techniques help to identify patterns and reveal relationships that may be too time-consuming, too error-prone, or otherwise difficult to efficiently and effectively carry out by manually programming logic or rules (e.g., nested if-then-else statements). For instance, the machine learning techniques described herein may be used for automated text mining and analysis of structured, semi-structured and unstructured input datasets of activities to: extract key concepts, patterns and relationships from large volumes of textual content; identify insights in textual content; summarize textual content to gain semantic understanding of the underlying content; and, index and search textual content for use in predictive analytics.

Examples of automated text mining and text analysis techniques include clustering, classification, association rules and predictive modeling. One method is to establish a set of significant keywords and groups of keywords, based on a statistical analysis of factors such as term frequency and term distribution. Higher scoring keywords and groups of keywords generally indicate higher probabilities of statistically significant relationship or patterns. Other methods to process text content include, either alone or in combination, natural language processing (NLP), parsing, tokenization (identification of distinct elements such as words or n-grams), stemming (reducing word variants to bases), term reduction (group like terms using synonyms and similarity measures) and parts-of-speech (POS) tagging. Processing can include more than mere word-association or frequency distribution.

The text mining and text analysis workflow can include numerous, automated steps, such as: receiving input datasets of activities for analysis; applying statistical, linguistic and structural analytical techniques; inferring meaning, discerning content, and applying parts-of-speech (POS) tagging; extracting concepts and patterns; applying statistical, machine learning, and pattern matching techniques; categorizing and classifying input datasets, and organizing per taxonomy; discerning meaning and relationships in large volumes of text; evaluating model performance by assessing precision, recall, accuracy and relevance; and presenting results to end-users, the results including the weighted probabilities dynamically generated and updated by machine learning techniques.

As a precursor to applying machine learning techniques, some embodiments implement a document term matrix (DTM), and use term frequency-inverse document frequency (TF-IDF) weighting, to extract and store underlying information such as standard features, keyword frequency, documents and text list features in the form of tables in a database. The tables can be queried for further analysis and processing. Some embodiments use numerous methods to organize, structure, and restructure text for content processing, such as clustering, categorization, taxonomy, classification, naïve Bayes, support vector machines, and K-nearest neighbor.

Input datasets used for training the ML models can be formatted as a file (e.g., CSV, Microsoft Excel formats, MPP, JSON, BIM, IFC, other), or a database (e.g., Oracle Primavera P6 Enterprise Project Portfolio Management, Oracle Primavera P6 Professional Project Management, other).

FIG. 10 includes an exemplary set of training data 903 for the Activities Classifier 121. As shown, the training data 903 can be formatted according to a table format 1000, wherein each row within rows 1006 represents a specific string indicative of an activity, and each column among columns 1004 represents a different weather event type, e.g., rain, snow, sleet, hail, mixed precipitation, wind speed, and wind gust. Each cell within cells 1008 can be populated with a 1 or a blank, wherein a “1” indicates that the corresponding activity is likely to be impacted by that corresponding weather event, and a blank indicates that the corresponding activity is not likely to be impacted by that corresponding weather event. Column 1002 includes the specific string indicative of an activity that Activities Classifier 121 is trained on. The strings within column 1002 can include text, symbols, codes, and/or descriptions derived from generally-accepted industry standards, classification systems, classification structures, information exchanges, data formats, and best practices for classifying and organizing information about the construction industry and built environment, such as: MasterFormat, UniFormat, OmniClass, Uniclass, NBS, EPIC, COBie, abbreviations and acronyms, and others. Shuffling the training datasets, to remove any order in each of the input datasets or in the data itself, helps to reduce bias in the ML models that can arise from non-random input.

MasterFormat is a specifications-writing standard for most commercial building design and construction projects in North America. MasterFormat lists titles and section numbers for organizing data about construction requirements, products, and activities. For example, MasterFormat titles and section numbers for the term “concrete” include: 03 00 00 Concrete; 03 30 00 Cast-in-Place Concrete; 03 31 00 Structural Concrete; 03 31 13 Heavyweight Structural Concrete; 03 31 16 Lightweight Structural Concrete; 03 31 19 Shrinkage-Compensating Structural Concrete; 03 31 23 High-Performance Structural Concrete; 03 31 24 Ultra High-Performance Structural Concrete; and 03 31 26 Self-Compacting Concrete. Input datasets of activities about “concrete” work results might contain one or many of the following, significant keywords and groups of keywords: concrete; cast-in-place concrete; structural concrete; heavyweight structural concrete; lightweight structural concrete; shrinkage-compensating structural concrete; high-performance structural concrete; ultra-high-performance structural concrete; self-compacting concrete, etc.

As another example, numerous abbreviations and acronyms are generally-accepted for the construction industry and building environment. Some abbreviations and acronyms related to the term “concrete” include: CONC Concrete; CMU Concrete Masonry Unit; CRSI Concrete Reinforcing Steel Institute; LWC Light Weight Concrete; NWC Normal Weight Concrete; SOG Slab on Grade; TOC Top of Concrete; TOF Top of Foundation. Input datasets of activities about “concrete” work results might contain one or many of the following significant keywords and groups of keywords: conc; concrete; cmu; concrete masonry unit; crsi; concrete reinforcing steel institute; lwc; light weight concrete; nwc; normal weight concrete; sog; slab on grade; toc; top of concrete; tof; top of foundation, etc.

Although schedule activities involving “concrete” may generally be impacted by precipitation events such as rain, snow, sleet, hail, and/or mixed precipitation, schedule activities that include the keyword “finishing” may not be impacted by such events, as the word “finishing” indicates the activities is occurring indoors.

Once Activities Classifier 121 is appropriately trained by training data (e.g., training data 903), Activities Classifier 121 will be ready to begin classifying schedule activities uploaded by the user (e.g., as part of client input data 131). For example, Activities Classifier may apply its trained machine learning model to one or more of the attributes extracted from each activity provided by the client. As discussed above with respect to FIG. 4, such attributes may be extracted at step 410, and may comprise one or more of Activity ID, Activity Code, Activity Name, and Activity Description. In some embodiments, the Activities Classifier may operate on the combination of one or more fields, or more operate on separate fields individually.

FIG. 11 includes an exemplary set of training data 709 for the Severe Weather Alert Meteorological Event Classifier 122. As shown, the training data 709 can also be formatted according to a table format 1100, wherein each row within rows 1106 represents a specific string that may be found in a severe weather alert text indicative of a weather event, and each column among columns 1104 represents a different weather event type, e.g., rain, snow, hail, mixed precipitation, wind speed, and wind gust. Each cell within cells 1108 can be populated with a 1 or a blank, wherein a “1” indicates that the corresponding weather alert text string indicates the corresponding weather event, and a blank indicates that the corresponding weather alert text string does not indicate the corresponding weather event. Column 1102 includes the specific string from weather alert text that Severe Weather Alert Meteorological Event Classifier is trained on. The strings within column 1102 can include text, symbols, codes, and/or descriptions derived from historical national weather service alert text (e.g., shown as 707 in FIG. 7).

Once the Severe Weather Alert Meteorological Event Classifier 122 is appropriately trained by training data (e.g., training data 709), the Severe Weather Alert Meteorological Event Classifier 122 will be ready to begin processing severe weather alert text issued by weather forecast authorities or sources in order to predict weather events indicated by said text. As discussed above, using machine training in this fashion can help to identify patterns and reveal relationships that may be too time-consuming, too error-prone, or otherwise impossible to efficiently and effectively carry out by manually programming logic or rules (e.g., nested if-then-else statements). For instance, the automated machine-learning processes discussed herein may determine that the term “rain” is generally associated with a rain event, but that the term “rain” when combined with or located near the term “boundary” may indicate a wind event, either in combination with or in place of, a rain event. This association may be made automatically by a computer implementing the machine-learning process discussed herein even though the term “rain boundary” may not have been expressly included within the training data 709.

The system may also implement end-user feedback loops, which enable end-users to correct false positive errors, false negative errors, or other erroneous results reached by Severe Weather Alert Meteorological Event Classifier 122, Weather Forecast Meteorological Event Classifier 123, and/or Activities Classifier 121. For example, a schedule activity containing the term “concrete” in its activity name field or activity description field may be classified by Activities Classifier 121 as impacted by a rain event. However, the schedule activity may not be impacted by a rain event if it also includes the term “submittal”, which indicates the schedule activity pertains to an administrative process (i.e., a submission of certain documents or forms), or if it also includes the term “interior”, which indicates the schedule activity is going to occur under a protective covering, such as an existing structure. The end-user feedback loop provides a mechanism for end-users to customize the ML model algorithm for their specific project or program by indicating which schedule activities had been incorrectly classified, and optionally by providing additional data that allows the ML model to differentiate future schedule activities in similar ways (e.g., following on the example above, by specifying that future schedule activities with the term “interior” or “submittal” should be understood to have no impacting weather events). Similarly, the subject matter expertise and industry domain knowledge of an end-user for a given project or program may help to identify many other relevant factors outside of the training datasets, which can then be included in the retraining of the ML model through the feedback loop.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. For example, while many of the examples disclosed herein relate to the construction industry, the embodiments described herein may also be applied to outdoor sporting events, outdoor performance events, outdoor military exercises, agriculture-related applications, or any type of short- or long-term project, program and/or operation whose outcome may be influenced by weather. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method for determining probable impacts of forecasted weather events on schedule activities, the method comprising:
receiving, at one or more processors, project activity data;
parsing the received project activity data using the one or more processors to determine one or more schedule activities;
instantiating, at the one or more processors, an activity model for each of the determined one or more schedule activities, wherein each activity model comprises one or more extracted activity attributes that are determined based on the received project activity data;
determining at the one or more processors, for each respective activity model of at least some of the instantiated activity models, one or more types of weather events that may impact the schedule activity corresponding to the respective activity model based on at least one of the extracted attributes for the respective activity model;
receiving, at the one or more processors, weather forecast data;
parsing the received weather forecast data using the one or more processors to determine one or more forecasted weather events, wherein each forecasted weather event comprises a predefined weather event data structure that defines a weather event type of a plurality of predefined weather event types;
processing each activity model to determine which, if any, activity models correspond to a schedule activity that may be impacted by a forecasted weather event; and
generating, using the one or more processors, a report specifying which of the one or more schedule activities may be impacted by any of the one or more forecasted weather events.

2. The method of claim 1, wherein the project activity data is formatted according to a file format.

3. The method of claim 1, wherein the project activity data is received via a database-to-database connection and is formatted according to a database format.

4. The method of claim 1, wherein the weather forecast data comprises text alerts issued by at least one weather forecast authority, wherein the text alerts have not been automatically generated by a computer but have been at least partially drafted by a human operator.

5. The method of claim 1, wherein the weather forecast data comprises time-series weather forecast data received from at least one of a weather forecast authority and a weather sensor.

6. The method of claim 1, wherein the one or more types of weather events that may impact the schedule activity corresponding to the respective activity model are determined using a multi-label classifier that has been trained according to a machine learning algorithm.

7. The method of claim 6, wherein the multi-label classifier is a support vector machine (SVM) classifier that defines a decision hyperplane that differentiates between sets of weather event types that may impact a particular schedule activity and sets of weather event types that are not expected to impact the particular schedule activity.

8. The method of claim 1, wherein the parsing of the received weather forecast data to determine one or more forecasted weather events is accomplished using a weather event classifier that has been trained according to a machine learning algorithm.

9. The method of claim 1, wherein the received project activity data is associated with a construction project, and wherein each schedule activity is a construction-related activity.

10. The method of claim 1, wherein the generated report is delivered via at least one of an email, a text message, a laptop or desktop push notification system, a mobile push notification system, an audible notification system, a visual notification system, and a watch push notification system.

11. A system for determining probable impacts of forecasted weather events on schedule activities, the system comprising:
one or more communications interfaces configured to receive project activity data and weather forecast data; and
one or more processors configured to:
parse the received project activity data to determine one or more schedule activities,
instantiate an activity model for each of the determined one or more schedule activities, wherein each activity model comprises one or more extracted activity attributes that are determined based on the received project activity data,
determine, for each respective activity model of at least some of the instantiated activity models, one or more types of weather events that may impact the schedule activity corresponding to the respective activity model based on at least one of the extracted attributes for the respective activity model,
parse the weather forecast data to determine one or more forecasted weather events, wherein each forecasted weather event comprises a predefined weather event data structure that defines a weather event type of a plurality of predefined weather event types,
process each activity model to determine which, if any, activity models correspond to a schedule activity that may be impacted by a forecasted weather event, and
generate a report specifying which of the one or more schedule activities may be impacted by any of the one or more forecasted weather events.

12. The system of claim 11, wherein the project activity data is formatted according to a file format.

13. The system of claim 11, wherein the project activity data is received via a database-to-database connection and is formatted according to a database format.

14. The system of claim 11, wherein the weather forecast data comprises text alerts issued by at least one weather forecast authority, wherein the text alerts have not been automatically generated by a computer but have been at least partially drafted by a human operator.

15. The system of claim 11, wherein the weather forecast data comprises time-series weather forecast data received from at least one of a weather forecast authority and a weather sensor.

16. The system of claim 11, wherein the one or more processors are configured to determine, for each respective activity model of at least some of the instantiated activity models, one or more types of weather events that may impact the schedule activity corresponding to the respective activity model using a multi-label classifier that has been trained according to a machine learning algorithm.

17. The system of claim 16, wherein the multi-label classifier is a support vector machine (SVM) classifier that defines a decision hyperplane that differentiates between sets of weather event types that may impact a particular schedule activity and sets of weather events that are not expected to impact the particular schedule activity.

18. The system of claim 11, wherein the one or more processors are configured to parse the received weather forecast data to determine one or more forecasted weather events using a weather event classifier that has been trained according to a machine learning algorithm.

19. The system of claim 11, wherein the received project activity data is associated with a construction project, and wherein each schedule activity is a construction-related activity.

20. The system of claim 11, wherein the one or more processors are configured to deliver the generated report via at least one of an email, a text message, a laptop or desktop push notification system, a mobile push notification system, an audible notification system, a visual notification system, and a watch push notification system.
